(19) United States
(12) Patent Application Publication
(10) Pub. No.: US 2025/0126436 A1
(43) Pub. Date: Apr. 17, 2025

(54) TECHNIQUES FOR INTER-VEHICLE SENSOR TARGET TRACKING

(71) Applicant: QUALCOMM Incorporated, San Diego, CA (US)

(72) Inventors: Preeti KUMARI, San Diego, CA (US); Anantharaman BALASUBRAMANIAN, San Diego, CA (US); Kapil GULATI, Belle Mead, NJ (US); Junyi LI, Fairless Hills, PA (US); Stelios STEFANATOS, San Diego, CA (US); Mahmoud ASHOUR, San Diego, CA (US)

(21) Appl. No.: 18/687,264

(22) PCT Filed: Oct. 27, 2022
(86) PCT No.: PCT/US2022/078796

§ 371 Date: Feb. 27, 2024

(30) Foreign Application Priority Data
Oct. 29, 2021 (GR) 20210100740

(51) Int. Cl. H04W 4/029; H04W 8/22; H04W 24/10; H04W 64/00

(52) U.S. Cl. CPC H04W 4/029; H04W 8/22; H04W 24/10; H04W 64/00

(57) ABSTRACT

Methods, systems, and devices for wireless communications are described. In some systems, a user equipment (UE) may identify a limited detection range, such as a Line of Sight (LoS) blockage or reduced coverage. The UE may request inter-vehicle assistance from a centralized control entity to overcome this limitation. The CE may transmit an indication of a set of target objects tracked by a sensor at the UE and a level of accuracy for tracking the set of target objects. In turn, the centralized control entity may request sensor information from one or more UEs with a complete LoS, a larger coverage area, or both. Based on the available sensor information, the centralized control entity may collect and transmit the sensor information back to the first UE in response to the request for assistance.

### CROSS REFERENCE

The present Application is a 371 national stage filing of International PCT Application No. PCT/US2022/078796 by KUMARI et al. entitled “TECHNIQUES FOR INTER-VEHICLE SENSOR TARGET TRACKING,” filed Oct. 27, 2022; and claims priority to Greece patent application No. 20210100740 by KUMARI et al., entitled “TECHNIQUES FOR INTER-VEHICLE SENSOR TARGET TRACKING” filed Oct. 29, 2021, each of which is assigned to the assignee hereof, and each of which is expressly incorporated by reference in its entirety herein.

### FIELD OF TECHNOLOGY

The following relates to wireless communications, including techniques for inter-vehicle sensor target tracking.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

### SUMMARY

A wireless multiple-access communications system may include one or more network entities (e.g., base stations) or one or more network access nodes, each simultaneously supporting communication for multiple communication devices, which may be otherwise known as user equipment (UE). In some cases, a UE (e.g., a vehicle equipped with one or more radar transmitters) may transmit radar waveforms in one or more directions to support sensor targeting (for example, to identify other UEs, pedestrians, obstructions, buildings, or some combination thereof). Data association and detection range for sensor targeting by a single UE may be improved.

The described techniques relate to improved methods, systems, devices, and apparatuses that support techniques for inter-vehicle sensor target tracking. A UE (e.g., a vehicle equipped with one or more radar transmitters) may transmit radar measurement signals in one or more directions, and may identify surrounding radar targets. The UE may transmit a radar waveform in a direction of a radar target and may identify one or more physical attributes of the radar target. To enhance sensor targeting, a UE may request information (e.g., radar tracking parameters) from one or more other UEs via a centralized control entity. This information sharing may occur periodically or when entering a geographical area. Based on the request, the centralized control entity may determine relevant UEs (for example, UEs with more complete line of sight (LoS) or larger coverage), allocate resources, and transmit requests for sensor tracking to the relevant UEs. The relevant UEs may send the requested data back to the centralized control entity using resources allocated by the centralized control entity, and the centralized control entity may collect and transmit the data to the UE requesting the information.

A method for wireless communication at a centralized control entity is described. The method may include receiving, from a first UE, a request for inter-UE tracking assistance to assist the first UE in tracking at least one target object in accordance with a level of accuracy, identifying a set of sensor parameters associated with a set of UEs and responsive to the request for inter-UE tracking assistance, and transmitting, to the first UE, assistance information for inter-UE tracking assistance based on the identified set of sensor parameters.

An apparatus for wireless communication at a centralized control entity is described. The apparatus may include a processor, memory coupled with the processor, and instructions stored in the memory. The instructions may be executable by the processor to cause the apparatus to receive, from a first UE, a request for inter-UE tracking assistance to assist the first UE in tracking at least one target object in accordance with a level of accuracy, identify a set of sensor parameters associated with a set of UEs and responsive to the request for inter-UE tracking assistance, and transmit, to the first UE, assistance information for inter-UE tracking assistance based on the identified set of sensor parameters.

Another apparatus for wireless communication at a centralized control entity is described. The apparatus may include means for receiving, from a first UE, a request for inter-UE tracking assistance to assist the first UE in tracking at least one target object in accordance with a level of accuracy, means for identifying a set of sensor parameters associated with a set of UEs and responsive to the request for inter-UE tracking assistance, and means for transmitting, to the first UE, assistance information for inter-UE tracking assistance based on the identified set of sensor parameters.

A non-transitory computer-readable medium storing code for wireless communication at a centralized control entity is described. The code may include instructions executable by a processor to receive, from a first UE, a request for inter-UE tracking assistance to assist the first UE in tracking at least one target object in accordance with a level of accuracy, identify a set of sensor parameters associated with a set of UEs and responsive to the request for inter-UE tracking assistance, and transmit, to the first UE, assistance information for inter-UE tracking assistance based on the identified set of sensor parameters.

Some examples of the method, apparatuses, and non-transitory computer-readable medium described herein may further include operations, features, means, or instructions for receiving, from the first UE, an indication of a set of target objects tracked by a sensor at the first UE and the level of accuracy for tracking the set of target objects including the at least one target object.

Some examples of the method, apparatuses, and non-transitory computer-readable medium described herein may further include operations, features, means, or instructions for transmitting, to the set of UEs, a request for the set of sensor parameters in response to the request for inter-UE tracking assistance.

Some examples of the method, apparatuses, and non-transitory computer-readable medium described herein may further include operations, features, means, or instructions for receiving, from the set of UEs, a set of responses to the request for the set of sensor parameters, where identifying the set of sensor parameters associated with the set of UEs may be based on the set of responses.

Some examples of the method, apparatuses, and non-transitory computer-readable medium described herein may further include operations, features, means, or instructions for determining that a target estimation accuracy associated with the at least one target object for at least one of the set of responses satisfies an accuracy threshold and including the target estimation accuracy for the at least one response in the set of sensor parameters based on the determining that the target estimation accuracy satisfies the accuracy threshold.

Some examples of the method, apparatuses, and non-transitory computer-readable medium described herein may further include operations, features, means, or instructions for selecting the set of UEs based on the indication of the set of target objects, the level of accuracy for tracking the set of target objects, and the request for inter-UE tracking assistance.

Some examples of the method, apparatuses, and non-transitory computer-readable medium described herein may further include operations, features, means, or instructions for receiving a capability indication from each UE of the set of UEs, the capability indication indicating that each UE of the set of UEs may be capable of participating in inter-UE tracking assistance, where selecting the set of UEs may be based on the received capability indication.

Some examples of the method, apparatuses, and non-transitory computer-readable medium described herein may further include operations, features, means, or instructions for selecting the set of UEs may be further based on at least one of a location for each UE of the set of UEs, a sector for each UE of the set of UEs, a mobility for each UE of the set of UEs, or a combination thereof.

Some examples of the method, apparatuses, and non-transitory computer-readable medium described herein may further include operations, features, means, or instructions for allocating a set of resources to the set of UEs based on receiving the request for inter-UE tracking assistance, where the set of sensor parameters may be based on the allocated set of resources.

In some examples of the method, apparatuses, and non-transitory computer-readable medium described herein, allocating the set of resources to the set of UEs may include operations, features, means, or instructions for allocating at least one of a set of time resources, a frequency band, a set of waveform parameters, or a combination thereof.

Some examples of the method, apparatuses, and non-transitory computer-readable medium described herein may further include operations, features, means, or instructions for receiving, from the first UE, one or more parameters prior to receiving the request for inter-UE tracking assistance.

Some examples of the method, apparatuses, and non-transitory computer-readable medium described herein may further include operations, features, means, or instructions for receiving the one or more parameters includes a periodic reception of the one or more parameters, or an event-triggered reception of the one or more parameters, or both.

In some examples of the method, apparatuses, and non-transitory computer-readable medium described herein, the one or more parameters include at least one of a location, a mobility, a predicted behavior, a predicted path, a sensor performance specification, a tracked target object list, a predicted target object list with predicted estimation accuracies, or a combination thereof.

In some examples of the method, apparatuses, and non-transitory computer-readable medium described herein, the request for inter-UE tracking assistance includes a periodic request for inter-UE tracking assistance, or an event-based request for inter-UE tracking assistance, or both.

In some examples of the method, apparatuses, and non-transitory computer-readable medium described herein, the first UE includes a vehicular UE and the centralized control entity includes a road-side unit.

A method for wireless communication at a first UE is described. The method may include transmitting, to a centralized control entity, a request for inter-UE tracking assistance to assist the first UE in tracking at least one target object in accordance with a level of accuracy and receiving, from the centralized control entity, assistance information for inter-UE tracking assistance based on a set of sensor parameters associated with a set of UEs and responsive to the request for inter-UE tracking assistance.

An apparatus for wireless communication at a first UE is described. The apparatus may include a processor, memory coupled with the processor, and instructions stored in the memory. The instructions may be executable by the processor to cause the apparatus to transmit, to a centralized control entity, a request for inter-UE tracking assistance to assist the first UE in tracking at least one target object in accordance with a level of accuracy and receive, from the centralized control entity, assistance information for inter-UE tracking assistance based on a set of sensor parameters associated with a set of UEs and responsive to the request for inter-UE tracking assistance.

Another apparatus for wireless communication at a first UE is described. The apparatus may include means for transmitting, to a centralized control entity, a request for inter-UE tracking assistance to assist the first UE in tracking at least one target object in accordance with a level of accuracy and means for receiving, from the centralized control entity, assistance information for inter-UE tracking assistance based on a set of sensor parameters associated with a set of UEs and responsive to the request for inter-UE tracking assistance.

A non-transitory computer-readable medium storing code for wireless communication at a first UE is described. The code may include instructions executable by a processor to transmit, to a centralized control entity, a request for inter-UE tracking assistance to assist the first UE in tracking at least one target object in accordance with a level of accuracy and receive, from the centralized control entity, assistance information for inter-UE tracking assistance based on a set of sensor parameters associated with a set of UEs and responsive to the request for inter-UE tracking assistance.

Some examples of the method, apparatuses, and non-transitory computer-readable medium described herein may further include operations, features, means, or instructions for transmitting, to the centralized control entity, an indication of a set of target objects tracked by a sensor at the first UE and the level of accuracy for tracking the set of target objects including the at least one target object.

Some examples of the method, apparatuses, and non-transitory computer-readable medium described herein may further include operations, features, means, or instructions for performing a set of measurements using the sensor at the first UE and determining that the at least one target object may be absent in the set of measurements, where transmitting the request for inter-UE tracking assistance may be based on determining that the at least one target object may be absent in the set of measurements.

Some examples of the method, apparatuses, and non-transitory computer-readable medium described herein may further include operations, features, means, or instructions for determining that a target estimation accuracy associated with the at least one target object does not satisfy a threshold, where transmitting the request for inter-UE tracking assistance may be based on determining that the target estimation accuracy does not satisfy the threshold.

Some examples of the method, apparatuses, and non-transitory computer-readable medium described herein may further include operations, features, means, or instructions for transmitting, to the centralized control entity, one or more parameters prior to transmitting the request for inter-UE tracking assistance.

Some examples of the method, apparatuses, and non-transitory computer-readable medium described herein may further include operations, features, means, or instructions for transmitting the one or more parameters includes a periodic transmission of the one or more parameters, or an event-triggered transmission of the one or more parameters, or both.

In some examples of the method, apparatuses, and non-transitory computer-readable medium described herein, the one or more parameters include at least one of a location, a mobility, a predicted behavior, a predicted path, a sensor performance specification, a tracked target object list, a predicted target object list with predicted estimation accuracies, or a combination thereof.

In some examples of the method, apparatuses, and non-transitory computer-readable medium described herein, the request for inter-UE tracking assistance includes a periodic request for inter-UE tracking assistance, or an event-based request for inter-UE tracking assistance, or both.

In some examples of the method, apparatuses, and non-transitory computer-readable medium described herein, the first UE includes a vehicular UE and the centralized control entity includes a road-side unit.

### BRIEF DESCRIPTION OF THE DRAWINGS

FIG. 1 illustrates an example of a wireless communications system that supports techniques for inter-vehicle sensor target tracking in accordance with aspects of the present disclosure.

FIG. 2 illustrates an example of a wireless inter-vehicle network that supports techniques for inter-vehicle sensor target tracking in accordance with aspects of the present disclosure.

FIG. 3 illustrates an example of a process flow that supports techniques for inter-vehicle sensor target tracking in accordance with aspects of the present disclosure.

FIGS. 4 and 5 show block diagrams of devices that support techniques for inter-vehicle sensor target tracking in accordance with aspects of the present disclosure.

FIG. 6 shows a block diagram of a communications manager that supports techniques for inter-vehicle sensor target tracking in accordance with aspects of the present disclosure.

FIG. 7 shows a diagram of a system including a device that supports techniques for inter-vehicle sensor target tracking in accordance with aspects of the present disclosure.

FIGS. 8 and 9 show block diagrams of devices that support techniques for inter-vehicle sensor target tracking in accordance with aspects of the present disclosure.

FIG. 10 shows a block diagram of a communications manager that supports techniques for inter-vehicle sensor target tracking in accordance with aspects of the present disclosure.

FIG. 11 shows a diagram of a system including a device that supports techniques for inter-vehicle sensor target tracking in accordance with aspects of the present disclosure.

FIGS. 12 through 15 show flowcharts illustrating methods that support techniques for inter-vehicle sensor target tracking in accordance with aspects of the present disclosure.

### DETAILED DESCRIPTION

Wireless communications systems (e.g., vehicle-to-everything (V2X) systems) may support radar sensing procedures. A user equipment (UE) (e.g., a vehicle equipped with one or more radar transmitters) may transmit radar waveforms in one or more directions, and may identify surrounding radar targets (e.g., objects such as other UEs (e.g., other vehicles), pedestrians, obstructions, buildings, or the like). In a V2X system, one or more UEs may each use a radar to identify a list of targets to track. For example, a UE may transmit a radar waveform in a direction of a radar target. Upon receiving a reflection of the radar waveform, the UE may identify one or more physical attributes of the radar target. That is, the reflection of the radar waveform may indicate the physical attributes of the radar target. Specifically, the UE may determine values for one or more radar measurement parameters (e.g., location, velocity, dimensions, orientation, and uncertainty values for each value) for the radar target. However, sensor targeting by a single vehicle is subject to limitations due to limited data association and detection range. For example, a single vehicle may monitor within its line-of-sight (LoS) and be susceptible to blockages. In some cases, these limitations may reduce situational awareness and consequently reduce safety, travel efficiency, and comfort features like cruise control and collision avoidance Thus, techniques for improved coverage of automotive sensors and situational awareness without reducing sensing performance are desired.

Accordingly, aspects of the present disclosure relate to enhanced sensor targeting through cooperative radar signaling between multiple UEs and their relative sensors. In some examples, multiple UEs (e.g., vehicle UEs (VUEs)) may use their respective radars to sense their environment and a one or more targets. One or more of the targets may be visible by all the UEs while other targets may be visible to some of the UEs. In other words, one or more of the targets may missing from a first UE's LOS, while being within the LoS for one or more other UEs. In some cases, the first UE may identify that a target is missing and transmit, to a centralized control entity (also referred to as a controller or a road-side unit (RSU)), a request for inter-UE tracking assistance. Based on the request, the centralized control entity may determine relevant UEs to assist, allocate resources, and may transmit new requests to the relevant UEs. The relevant UEs may respond with the requested data, using the resources allocated by the centralized control entity. The centralized control entity may then collect and transmit the requested data back to the first UE.

Particular aspects of the subject matter described herein may be implemented to realize one or more advantages. The described techniques may support improvements in wireless communications systems by reducing signaling interference. Further, in some examples, inter-UE handover, as described herein, may support intelligent target tracking information sharing between UEs, thereby improving target tracking estimation accuracy, object association, and large sensing coverage. As such, supported techniques may include improved vehicular safety, comfort, and traffic efficiency, among other benefits.

Aspects of the disclosure are initially described in the context of wireless communications systems. Aspects of the disclosure are additionally described in the context of a wireless inter-vehicle network and a process flow. Aspects of the disclosure are further illustrated by and described with reference to apparatus diagrams, system diagrams, and flowcharts that relate to techniques for inter-vehicle sensor target tracking.

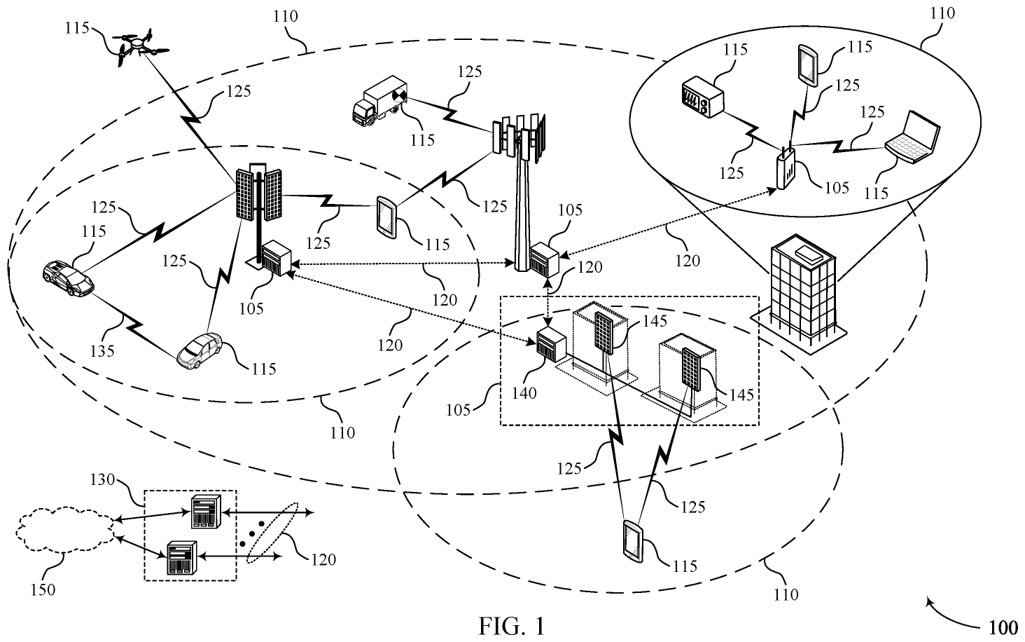

FIG. 1 illustrates an example of a wireless communications system 100 that supports techniques for inter-vehicle sensor target tracking in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entity 105 (e.g., centralized control entity, base station) may be dispersed throughout a geographic area to form the wireless communications system 100 and may be devices in different forms or having different capabilities. The network entity 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

The network entity 105 may communicate with the core network 130, or with one another, or both. For example, the network entity 105 may interface with the core network 130 through one or more backhaul links 120 (e.g., via an S1, N2, N3, or other interface). The network entity 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio network entity, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities 105 (e.g., network nodes, base stations) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140 (e.g., access base station), which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity (e.g., base station) antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

According to one or more aspects of the present disclosure, a first UE 115 may use sensor signals to sense and track nearby objects (also referred to as a target). In some examples, the first UE 115 may employ automotive radar to sense the environment to enable safety and comfort features, such as collision avoidance and adaptive cruise control. Automotive radar transmits a signal periodically to sense the environment at high update rate. The signal is reflected by the surrounding objects and the echoes are received at the radar receiver in full-duplex configuration. The received signal is then processed to estimate the two-way monostatic channel parameters at the first UE 115. In some cases, the first UE 115 may employ automotive radar to sense the environment and enable safety and comfort features, such as collision avoidance and adaptive cruise control. For example, a UE may transmit an automotive radar periodically to sense the environment at a high update rate and to track, characterize the state, and predict the behavior of relevant targets.

In some cases, the first UE 115 may measure a set of values for one or more parameters associated with each target it senses. For example, the parameters may include a range profile, a velocity profile, an angular profile, a radar signature to enable target classification, an estimate of target shape and size, target tracking, and target behavior and path predication. However, sensor targeting by a single UE is subject to limitations due to poor data association and limited detection range. A single UE may have limited coverage, such as a limited field of view (FoV), limited detection range, or monitoring limited to within its LoS. Additionally or alternatively, the first UE 115 may have limited acceleration estimation based on positioning and motion direction, low probability of detection and poor data association due to poor radar cross-sections (RCSs), low tracking estimation accuracy due to general sensor errors, poor classification and boundary detection due to sparse point clouds, or a combination thereof. Additionally or alternatively, as the number of UEs within a coverage area increases, radar interference may also increase.

In some examples, enhanced cooperative radar signaling may be implemented to reduce radar interference. The enhanced cooperative radar signaling may include joint communication radar (JCR) systems. For example, the wireless communications system 100 may include co-located and cooperative radar and communication systems, where radar information is shared between the systems without altering their core system operations. Additionally or alternatively, the wireless communications system 100 may include a co-design system, where transmitters and receivers are used for both radar and communication operations. For example, transmitter operations, receiver operations, or both may include modification in order to be radar-centric, communication-centric, or a joint-design. Thus, vehicles may employ automotive radar to sense the environment to enable safety, traffic efficiency, and comfort features, such as collision avoidance and adaptive cruise control. Radar sensors mounted on a single vehicle may provide limited local situational awareness to avoid potential collisions and enable enhanced comfort features. Additionally, or alternatively, with the increase in the number of vehicles within a given coverage area, using all radars for sensor sharing to obtain the global situational awareness may reduce the sensing performance. Thus, sensor tracking techniques may be improved.

According to one or more aspects depicted herein, the first UE 115 may transmit UE data (for example, the first UE 115's location, mobility, predicted path, and sensor performance specifications) as well as the target measurements, to a centralized control unit, which may be an example of a network entity 105. In some examples, the first UE 115 may transmit the UE data and measurements periodically. Additionally or alternatively, the first UE 115 may transmit the UE data and measurements based on an event (for example, upon entering a controller area or a geographic location). In some cases, the first UE 115 may determine that a target is missing from its measurements. The UE 115 may transmit a request for inter-UE tracking assistance to the centralized control unit. Upon receiving the request, the centralized control entity (e.g., network entity 105) may determine relevant UEs 115 to assist and request, from the relevant UEs 115, sensor parameters responsive to the inter-UE tracking assistance request. The relevant UEs may transmit the requested sensor parameters to the centralized control entity, and the centralized control entity may collect and transmit the information to the first UE 115. Thus, combining inter-UE tracking assistance with its own sensor measurements, the first UE 115 may obtain more comprehensive target tracking information and increase overall safety, vehicle comfort, and traffic efficiency.

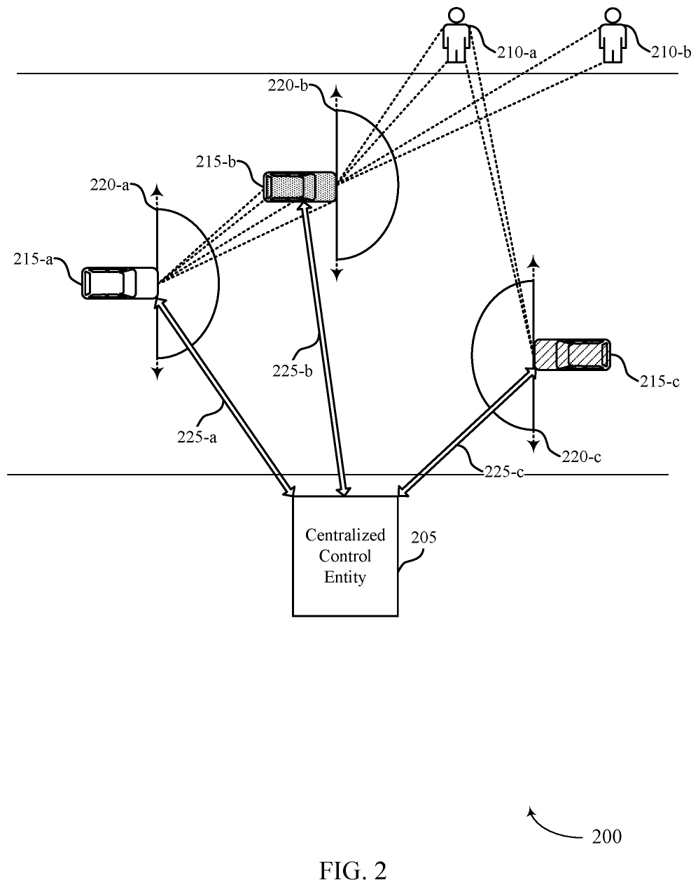

FIG. 2 illustrates an example of a wireless inter-vehicle network 200 that supports techniques for inter-vehicle sensor target tracking in accordance with aspects of the present disclosure. In some examples, the wireless inter-vehicle network 200 may implement aspects of wireless communications system 100 (e.g., the UEs 215 may be examples of the UE 115). The wireless inter-vehicle network 200 may include a centralized control entity 205, one or more targets 210 (e.g., target 210-a and target 210-b), one or more UEs 215 (e.g., UE 215-a, UE 215-b, and UE 215-c), their respective sensing coverage based on their physical location within wireless inter-vehicle network 200, and their respective communications with centralized control entity 205. In some examples, UEs 215 may be vehicles (e.g., in a V2X system) equipped with sensors, or may be vehicles carrying or connected to other UEs, or the like. For example, UE 215 may be an example of a vehicle with radar transmitter (or other sensor transmitter). The UE 215 may use the radar transmitter to perform target measurements within sensing range 220.

In some examples, UEs 215 may perform sensor measurements (e.g., by radar sensing) to identify one or more targets. For instance, UEs 215 may attempt to identify other UEs 215 (e.g., other vehicles, other devices carried by pedestrians or within other vehicles, or the like) or targets 210 (e.g., pedestrians, structures, or the like). In performing radar sensing, a UE 215 may transmit and monitor for a radar measurement signal. For instance, the UE 215-a may transmit radar measurement signal (e.g., radar waveform). In some examples, the UEs 215 may include one or more sensors (e.g., radar transmitters), which may be oriented in multiple directions to perform sensing in multiple directions. In cases where the UE is a vehicle, sensors may be mounted on driver or passenger doors, rear bumpers or trunks, front bumpers or hoods, or some combination thereof. For instance, a transmitter mounted on the front of the UE 215-a may transmit a measurement signal in a forward direction (e.g., the direction viewed by the driver of the UE 215-a). The UE 215-a may monitor for a reflection of the radar measurement signal. In some examples, the radar measurement signal may be, for instance, a frequency modulated continuous waveform (FMCW) waveform, and may sweep through a frequency range over time. Based on the quantity and orientation of sensors, the UEs 215 may have variable sensing ranges 220.

As depicted in the example of FIG. 2, a UE 215 (e.g., a vehicle such as UE 215-a) may support sensor measurements within a LoS of sensing range 220. In some examples, a UE 215 may experience radar interference or blockage. For example, another UE 215 or some other object may block the target 210 from the sensing range 220. For example, the UE 215-a may be unable to detect a target 210-a and a target 210-b due to the UE 215-b blocking the UE 215-a's LoS. Due to the location of the UE 215-a and the UE 215-b, the UE 215-a may not be able to effectively measure the targets 210-a and 210-b. In such examples, the UE 215-a may fail to detect or track the presence, location, velocity, or other target parameters of the targets 210-a and 210-b. Similarly, other UEs 215, targets 210, or other obstacles may be invisible with respect to sensor measurements for UE 215-a. Additionally or alternatively, a UE 215 may be unable to detect targets located outside of the respective sensing range 220. For example, the UE 215-c may not be able to detect the target 210-b, due to the target 210-b's location beyond the sensing range 220-c. In contrast, the UE 215-c may be able to detect the target 210-a, due to the target 210-a's location within the sensing range 220-c without any obstruction.

According to aspects depicted in the present disclosure, a first UE may transmit an indication of a set of target objects tracked by a sensor at the first UE. The first UE may transmit a request for inter-UE tracking assistance to assist the first UE in tracking at least one target object of the set of target objects. In some examples, there may not be a set of target object tracked by a sensor at the first UE, such as if an object is not measured by the first UE. In some cases, the first UE may receive assistance information for inter-UE tracking assistance based on an identified set of sensor parameters. For example, the UE 215-a may transmit sensor signal to detect and track a set of nearby objects (also referred to as targets or target objects). In some cases, the UE 215-a may transmit its location, mobility, predicted behavior, predicted path, and sensor performance specifications (e.g., range of sensing range 220-a) to a centralized control entity 205. Additionally or alternatively, the UE 215-a may indicate the set of target objects to the centralized control entity 205. For example, the UE 215-a may transmit a tracked or predicted target object list, and a level of accuracy for tracking the set of target objects. In some examples, the UE 215-a may transmit the aforementioned information periodically. Additionally or alternatively, the transmission may be triggered by an event. For example, the UE 215-a may transmit the information to the centralized control entity 205 if the UE 215-a enters a control area of the centralized control entity 205 or if the UE 215-a enters a zone based on a geographic location.

In some cases, the UE 215-a may transmit an inter-UE tracking assistance request (e.g., an inter-vehicle radar target tracking handover request) to the centralized control entity 205. In some cases, the request may include one or more tracking parameters. For example, the UE 215-a may request periodic target tracking from the centralized control entity 205. In some examples, the periodic target tracking may be associated with an update rate based on traffic congestion, a sensing parameter, or some combination thereof.

In some other cases, the inter-UE tracking assistance request may be associated with an event-based inter-UE tracking assistance, such as inter-vehicle radar handover for a target 210. In some examples, the UE 215-a may determine that a tracked object (e.g., the target 210-a or target 210-b), is missing from some measurements. For example, the target 210 may be blocked by another UE 215 (e.g., UE 215-b) or another object. Additionally or alternatively, the target 210 may be outside of the UE 215-a's sensing range 220. In some other examples, the UE 215-a may have poor predicted tracking estimation accuracy. The UE 215-a may determine that a target estimation accuracy associated with the at least one target object does not satisfy a threshold. For example, if the UE 215-a is performing sensor measurements from a large range or with a limited field of view (FoV), the tracking estimation accuracy may be poor (or less than a threshold). The UE 215-a may request an event-based inter-vehicle radar handover for a particular target for a given duration based on determining that the target estimation accuracy associated with the at least one target object does not satisfy the threshold. In some other examples, UE 215-a may predict collision (e.g., in an upcoming time period) from another object and may request tracking information for that object (e.g., soft-handover information for that object) to avoid the collision with high accuracy.

As depicted in the example of FIG. 2, the centralized control entity 205 may receive a request for inter-UE tracking assistance (e.g., from the UE 215-a). Based on the inter-UE tracking assistance request, the centralized control entity 205 may determine and select relevant nearby UEs 215 (e.g., 215-b and 215-c) to assist the first UE 215 (e.g., 215-a). In some cases, the centralized control entity 205 may select the relevant UEs 215 based on their location, sector, mobility, or some combination thereof. For example, if the first UE 215-a has a known blockage due to the UE 215-b, and the UE 215-b is near a high-risk area (e.g., a sidewalk), then the centralized control entity 205 may select the UE 215-b as one of the relevant UE 215. In some cases, the centralized control entity 205 may have a list of preidentified UEs 215 that are capable and willing in participating in the inter-UE tracking or handover. In some cases, the centralized control entity 205 may check with relevant UEs 215 to determine whether they are capable and willing to participate in the inter-UE tracking assistance or handover. The centralized control entity 205 may transmit a request for the set of sensor parameters in response to the request for inter-UE tracking assistance.

Additionally or alternatively, the centralized control entity 205 may decide a mode of handover and the relevant UEs 215. For example, the centralized control entity 205 may enable a radar target tracking handover from the first UE 215-a to the UE 215-b. In other words, the targets that are missing or have poor target estimation accuracy when measured by the first UE 215-a may be assigned to be tracked by another UE 215 with desirable predicted target tracking estimation accuracy. If the centralized control entity 205 determines that no UEs 215 have a predicted target tracking estimation accuracy satisfying a threshold for a given duration, then the centralized control entity 205 may enable a soft-handover between one or more UEs 215. In other words, multiple UEs 215 may collaborate to track the target 210 with an estimation accuracy until one of the UEs 215 is able to track the target with an accuracy satisfying a threshold. When one of the UEs 215 has predicted target tracking estimation accuracy satisfying the threshold, the centralized control entity 205 may enable a hard radar target tracking from the first UE 215-a. In some examples, the inter-vehicle radar target tracking handover may occur without the centralized control entity 205 and may instead use sidelink communications between multiple UEs 215.

The centralized control entity 205 may allocate a set of resources for all the relevant UEs 215 for enhanced target tracking with minimal interference. In some examples, different resources or the same resources may be allocated to each UE 215. For example, resources allocated to UE 215-a may be different than resources allocated to UE 215-b, or resources allocated to UE 215-a may be the same resources as allocated to UE 215-b. In some cases, the set of resources may include a set of time resources, a frequency band, a set of waveform parameters, or a combination thereof.

In some cases, the centralized control entity 205 may transmit requests to the relevant UEs 215 for assistance information, such as sensor parameters. Additionally or alternatively, the centralized control entity 205 may transmit parameters, suggestions for periodic or target tracking handover, or both. For example, the centralized control entity 205 may suggest a FoV, a detection range, an unambiguous velocity estimation, or some combination thereof.

In some cases, based on receiving the requests from the centralized control entity 205, one or more of the relevant UEs 215 (e.g., UEs 215-b and 215-c) may transmit the requested assistance information to the centralized control entity 205. In some cases, the assistance information may include a location, mobility, predicted behavior, predicted path, sensor performance specification, a tracked target object list, a predicted target object list, predicted estimation accuracies, or some combination thereof. In some examples, the assistance information may be associated with a target 210, the first UE 215 (e.g., UE 215-a), or the assisting UEs 215 (e.g., UEs 215-b and 215-c), or some combination thereof.

In some cases, the centralized control entity 205 may receive the assistance information from the relevant UEs 215-b and 215-c. In some examples, the centralized control entity 205 may receive the assistance information periodically or based on an event-triggered handover request to assist the first UE 215-a. In some cases, the centralized control entity 205 may compile the assistance information before transmitting it to the first UE 215-a. In other cases, the centralized control entity 205 may transmit the raw assistance information to the first UE 215-a. In some cases, the first UE 215 (e.g., UE 215-a) may combine its own sensor with the inter-UE tracking information to track the targets 210.

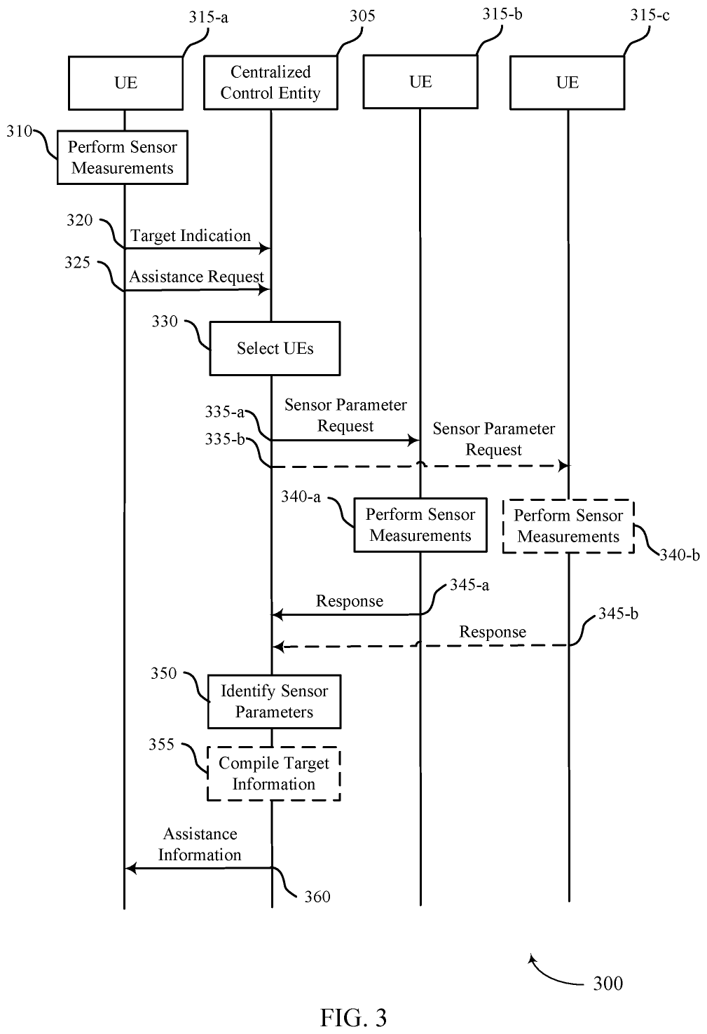

FIG. 3 illustrates an example of a process flow 300 that supports techniques for inter-vehicle sensor target tracking in accordance with aspects of the present disclosure. In some examples, process flow 300 may implement aspects of wireless communications systems 100 as described with reference to FIG. 1 and wireless inter-vehicle network 200 as described with reference to FIG. 2. For example, the process flow 300 may include the centralized control entity 305 which may be an example of the centralized control entity 205 as described with reference to FIG. 2. Additionally, the centralized control entity 305 may be an example of a network entity (e.g., base station), an RSU, a repeater node, an access point, or the like. Further, the process flow 300 may include UEs 315 (e.g., UE 315-a, UE 315-b, and 315-c) which may be examples of UEs 215 (e.g., vehicle UEs) as described with reference to FIG. 2. Alternative examples of the following may be implemented, where some operations are performed in a different order than described or are not performed at all. In some cases, operations may include additional features not mentioned below, or further operations may be included.

In some cases, UEs 315 may be proximal to one another and may engage in communications with one another via a wired or wireless connection (e.g., a sidelink connection, a Bluetooth connection, etc.). Additionally, one or both of the UEs 315 may be in a coverage zone corresponding to the centralized control entity 305. As such, the UEs 315 may be connected to the centralized control entity 305.

At 310, the UE 315-a may perform a set of measurements, which may include one or more sensor measurements. For example, the UE 315-a may transmit sensor signals (e.g., using a radar sensor, lidar sensor, or both) to detect and track a set of nearby objects (also referred to as targets or target objects). In some examples, the set of measurements may include one or more of a range profile, a velocity profile, an angular profile, a radar signature to enable target classification, an estimate of target shape and size, target tracking, target behavior, and path predication. Based on performing the set of measurements, the UE 315-a may determine that a target is missing from the set of target measurements. Additionally or alternatively, the UE 315-a may determine that a target estimation accuracy associated with the at least one target object does not satisfy a threshold.

At 320, the UE 315-a may transmit an indication of the set of target objects. to a centralized control entity 305. In some cases, the UE 315-a may also indicate the level of accuracy for tracking the set of target objects. In some cases, the UE 315-a may transmit one or more parameters to the centralized control entity 305. For example, the parameters may include a location, a mobility, a predicted behavior, a predicted path, a sensor performance specification, a tracked target object list, a predicted target object list with predicated estimation accuracies, or a combination thereof. The parameters may be transmitted periodically or upon a triggering event.

At 325, the UE 315-a may transmit an assistance request, such as a request for inter-UE tracking assistance to track one or more of the targets. In some cases, the request may be for tracking a missing target. In some other cases, the request may be for tracking a target having a target estimation accuracy less than a threshold. Additionally or alternatively, the assistance request may indicate a periodic assistance or an event-based assistance.

At 330, based upon receiving the target indication, the assistance request, or both, the centralized control entity 305 may identify and select relevant UEs 315 to assist the UE 315-a. In some cases, the centralized control entity 305 may select the UEs 315 (e.g., UE 315-b and UE 315-c) based on the indication of the set of target objects, the level of accuracy for tracking the set of target objects, the request for inter-UE tracking assistance, or a combination thereof. In some cases, the centralized control entity 305 may select UEs 315-b and 315-c based on one or more of their relative locations, sectors, mobilities, or a combination thereof. Additionally or alternatively, the centralized control entity 305 may select the UEs 315 based on a capability indication from the UEs 315, the capability indication indicating whether a UE 315 can participate in inter-UE tracking assistance.

In some examples, the centralized control entity 305 may select one UE 315, such as UE 315-a, to provide assistance. Additionally or alternatively, the centralized control entity 305 may select more than one UE 315 (such as UE 315-a and 315-b) to provide assistance to the UE 315-a. Upon selecting the UEs 315, the centralized control entity 305 may allocate resources for each UE 315. For example, the centralized control entity 305 may allocate at least one of a set of time resources, a frequency band, a set of waveform parameters, or a combination thereof.

At 335-a and 335-b, the centralized control entity 305 may transmit sensor parameter requests to each of the selected UEs 315-b and 315-c. In some cases, the centralized control entity 305 may transmit the sensor parameter requests to the UEs 315-b and 315-c based on receiving the assistance request from the UE 315-a. In some cases, the requests may include one or more parameters or a handover parameter.

At 340-a, upon receiving the sensor parameter request, the selected UE 315-b may perform one or more measurements on the indicated targets. At 340-b, upon receiving the sensor parameter request, the selected UE 315-c may optionally perform one or more measurements on the indicated targets. The measurements may be performed based on the parameters included in the sensor parameter requests.

At 345-a, the UE 315-b may transmit, to the centralized control entity 305, a response to the relative sensor parameter request. At 345-b, the UE 315-c may optionally transmit, to the centralized control entity 305, a response to the relative sensor parameter request. The responses may include sensor parameters for one or more targets. In some cases, the parameters may include a location, a mobility, a predicted behavior, a predicted path, a sensor performance specification, a tracked target object list, a predicted target object list with predicted estimation accuracies, or a combination thereof.

At 350, the centralized control entity 305 may assess the responses from the UEs 315 and identify the sensor parameters for one or more targets. In some cases, the centralized control entity 305 may maintain the sensor parameters in their original form. In some other cases, as depicted at 355, the centralized control entity 305 may use the sensor parameters to compile target information. For example, the centralized control entity 305 may determine that a target estimation accuracy included in a response from the UE 315-b satisfies an accuracy threshold. If the accuracy threshold is satisfied, the centralized control entity 305 may include the sensor parameters from UE 315-b in the target information.

At 360, the centralized control entity 305 may transmit assistance information in response to the assistance request. For example, the centralized control entity 305 may transmit to the UE 315-a, sensor parameters from UE 315-b, UE 315-c, or both. Upon receiving the assistance information, the UE 315-a may use its own sensor measurements, the received target information, or a combination thereof, to track the one or more targets.

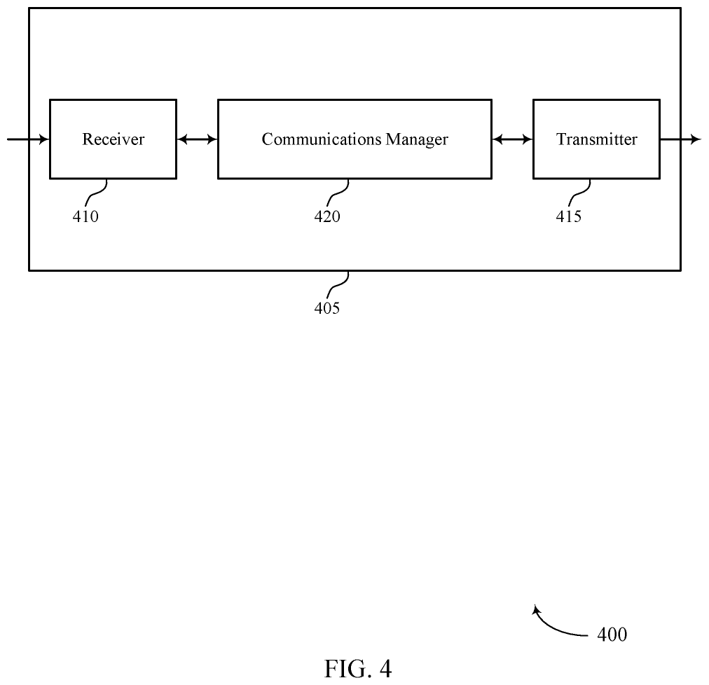

FIG. 4 shows a block diagram 400 of a device 405 that supports techniques for inter-vehicle sensor target tracking in accordance with aspects of the present disclosure. The device 405 may be an example of aspects of a centralized control entity as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for inter-vehicle sensor target tracking). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for inter-vehicle sensor target tracking). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for inter-vehicle sensor target tracking as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a centralized control entity in accordance with examples as disclosed herein. For example, the communications manager 420 may be configured as or otherwise support a means for receiving, from a first UE, an indication of a set of target objects tracked by a sensor at the first UE and a level of accuracy for tracking the set of target objects. The communications manager 420 may be configured as or otherwise support a means for receiving, from the first UE, a request for inter-UE tracking assistance to assist the first UE in tracking at least one target object of the set of target objects. The communications manager 420 may be configured as or otherwise support a means for identifying a set of sensor parameters associated with a set of UEs and responsive to the request for inter-UE tracking assistance. The communications manager 420 may be configured as or otherwise support a means for transmitting, to the first UE, assistance information for inter-UE tracking assistance based on the identified set of sensor parameters.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing and more efficient utilization of communication resources.

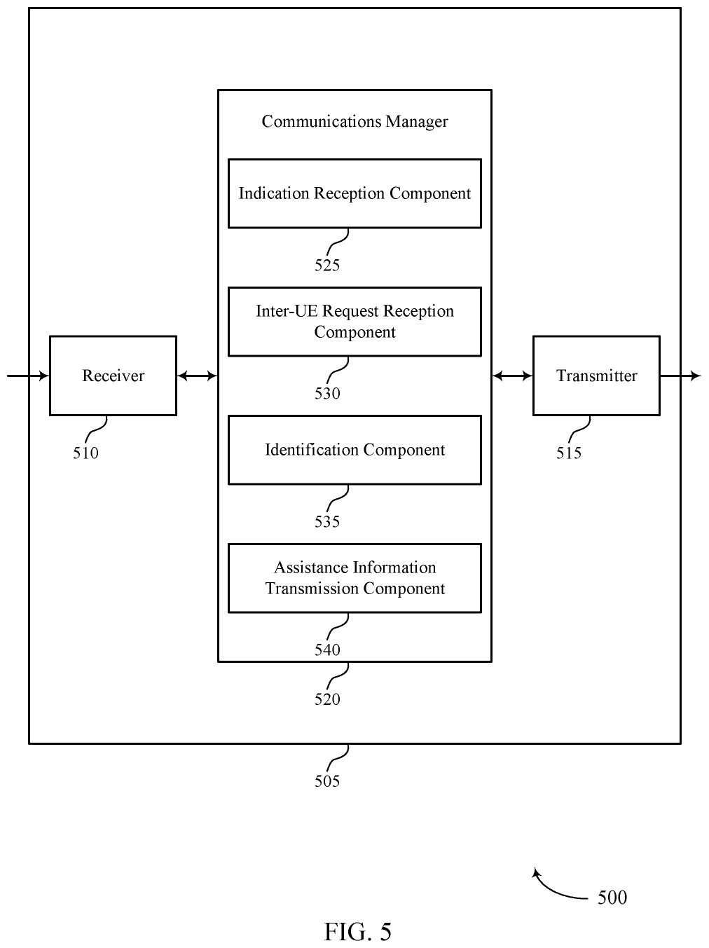

FIG. 5 shows a block diagram 500 of a device 505 that supports techniques for inter-vehicle sensor target tracking in accordance with aspects of the present disclosure. The device 505 may be an example of aspects of a device 405 or a network entity 105 (e.g., centralized control entity 105) as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for inter-vehicle sensor target tracking). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for inter-vehicle sensor target tracking). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for inter-vehicle sensor target tracking as described herein. For example, the communications manager 520 may include an indication reception component 525, an inter-UE request reception component 530, an identification component 535, an assistance information transmission component 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a centralized control entity in accordance with examples as disclosed herein. The indication reception component 525 may be configured as or otherwise support a means for receiving, from a first UE, an indication of a set of target objects tracked by a sensor at the first UE and a level of accuracy for tracking the set of target objects. The inter-UE request reception component 530 may be configured as or otherwise support a means for receiving, from the first UE, a request for inter-UE tracking assistance to assist the first UE in tracking at least one target object of the set of target objects. The identification component 535 may be configured as or otherwise support a means for identifying a set of sensor parameters associated with a set of UEs and responsive to the request for inter-UE tracking assistance. The assistance information transmission component 540 may be configured as or otherwise support a means for transmitting, to the first UE, assistance information for inter-UE tracking assistance based on the identified set of sensor parameters.

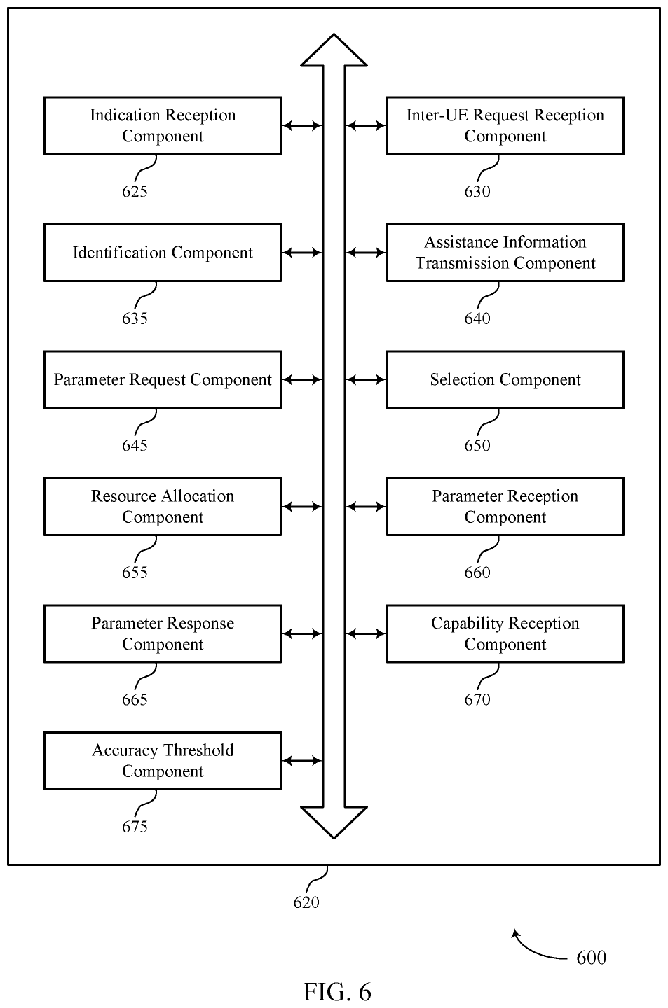

FIG. 6 shows a block diagram 600 of a communications manager 620 that supports techniques for inter-vehicle sensor target tracking in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for inter-vehicle sensor target tracking as described herein. For example, the communications manager 620 may include an indication reception component 625, an inter-UE request reception component 630, an identification component 635, an assistance information transmission component 640, a parameter request component 645, a selection component 650, a resource allocation component 655, a parameter reception component 660, a parameter response component 665, a capability reception component 670, an accuracy threshold component 675, or any combination thereof. Each of these components may communicate, directly or indirectly, with one another (e.g., via one or more buses).

The communications manager 620 may support wireless communication at a centralized control entity in accordance with examples as disclosed herein. The indication reception component 625 may be configured as or otherwise support a means for receiving, from a first UE, an indication of a set of target objects tracked by a sensor at the first UE and a level of accuracy for tracking the set of target objects. The inter-UE request reception component 630 may be configured as or otherwise support a means for receiving, from the first UE, a request for inter-UE tracking assistance to assist the first UE in tracking at least one target object of the set of target objects. The identification component 635 may be configured as or otherwise support a means for identifying a set of sensor parameters associated with a set of UEs and responsive to the request for inter-UE tracking assistance. The assistance information transmission component 640 may be configured as or otherwise support a means for transmitting, to the first UE, assistance information for inter-UE tracking assistance based on the identified set of sensor parameters.

In some examples, the parameter request component 645 may be configured as or otherwise support a means for transmitting, to the set of UEs, a request for the set of sensor parameters in response to the request for inter-UE tracking assistance. In some examples, the parameter response component 665 may be configured as or otherwise support a means for receiving, from the set of UEs, a set of responses to the request for the set of sensor parameters, where identifying the set of sensor parameters associated with the set of UEs is based on the set of responses.

In some examples, the accuracy threshold component 675 may be configured as or otherwise support a means for determining that a target estimation accuracy associated with the at least one target object for at least one of the set of responses satisfies an accuracy threshold. In some examples, the assistance information transmission component 640 may be configured as or otherwise support a means for including the target estimation accuracy for the at least one response in the set of sensor parameters based on the determining that the target estimation accuracy satisfies the accuracy threshold.

In some examples, the selection component 650 may be configured as or otherwise support a means for selecting the set of UEs based on the indication of the set of target objects, the level of accuracy for tracking the set of target objects, and the request for inter-UE tracking assistance. In some examples, the capability reception component 670 may be configured as or otherwise support a means for receiving a capability indication from each UE of the set of UEs, the capability indication indicating that each UE of the set of UEs is capable of participating in inter-UE tracking assistance, where selecting the set of UEs is based on the received capability indication.

In some examples, selecting the set of UEs is further based on at least one of a location for each UE of the set of UEs, a sector for each UE of the set of UEs, a mobility for each UE of the set of UEs, or a combination thereof. In some examples, the resource allocation component 655 may be configured as or otherwise support a means for allocating a set of resources to the set of UEs based on receiving the request for inter-UE tracking assistance, where the set of sensor parameters is based on the allocated set of resources.

In some examples, to support allocating the set of resources to the set of UEs, the resource allocation component 655 may be configured as or otherwise support a means for allocating at least one of a set of time resources, a frequency band, a set of waveform parameters, or a combination thereof. In some examples, the parameter reception component 660 may be configured as or otherwise support a means for receiving, from the first UE, one or more parameters prior to receiving the request for inter-UE tracking assistance.

In some examples, receiving the one or more parameters includes a periodic reception of the one or more parameters, or an event-triggered reception of the one or more parameters, or both. In some examples, the one or more parameters include at least one of a location, a mobility, a predicted behavior, a predicted path, a sensor performance specification, a tracked target object list, a predicted target object list with predicted estimation accuracies, or a combination thereof.

In some examples, the request for inter-UE tracking assistance includes a periodic request for inter-UE tracking assistance, or an event-based request for inter-UE tracking assistance, or both. In some examples, the first UE includes a vehicular UE and the centralized control entity includes a road-side unit. In some examples, the sensor includes a radar sensor, or a lidar sensor, or both.

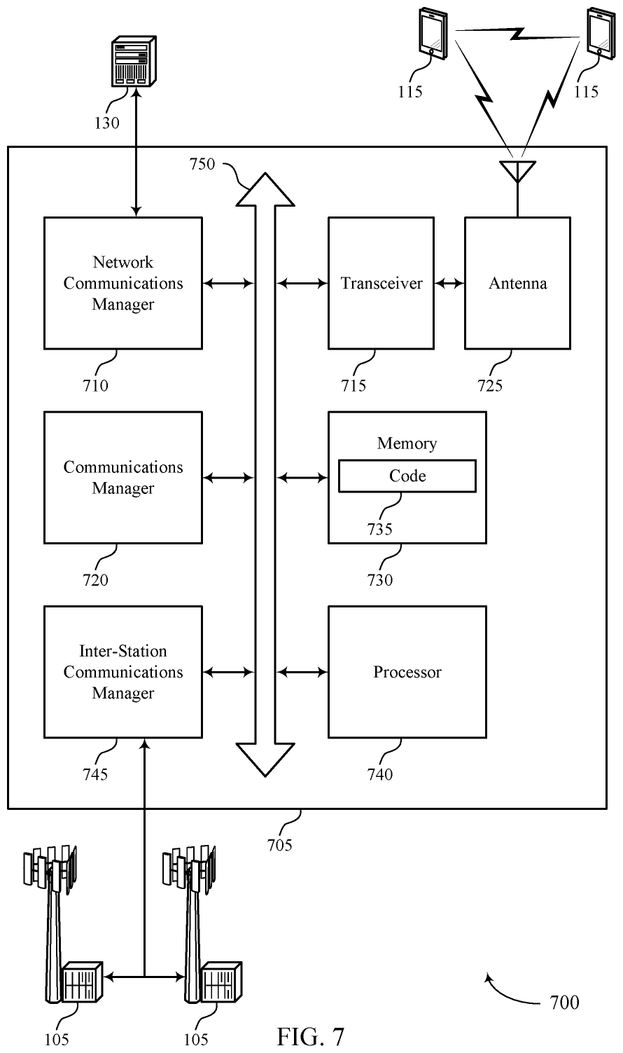

FIG. 7 shows a diagram of a system 700 including a device 705 that supports techniques for inter-vehicle sensor target tracking in accordance with aspects of the present disclosure. The device 705 may be an example of or include the components of a device 405, a device 505, or a centralized control entity as described herein. The device 705 may include components for bi-directional voice and data communications including components for transmitting and receiving communications, such as a communications manager 720, a network communications manager 710, a transceiver 715, an antenna 725, a memory 730, code 735, a processor 740, and an inter-station communications manager 745. These components may be in electronic communication or otherwise coupled (e.g., operatively, communicatively, functionally, electronically, electrically) via one or more buses (e.g., a bus 750).

The network communications manager 710 may manage communications with a core network 130 (e.g., via one or more wired backhaul links). For example, the network communications manager 710 may manage the transfer of data communications for client devices, such as one or more UEs 115.

In some cases, the device 705 may include a single antenna 725. However, in some other cases the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a BIOS which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for inter-vehicle sensor target tracking). For example, the device 705 or a component of the device 705 may include a processor 740 and memory 730 coupled to the processor 740, the processor 740 and memory 730 configured to perform various functions described herein.

The inter-station communications manager 745 may manage communications with other network entities 105 and may include a controller or scheduler for controlling communications with UEs 115 in cooperation with other network entities 105. For example, the inter-station communications manager 745 may coordinate scheduling for transmissions to UEs 115 for various interference mitigation techniques such as beamforming or joint transmission. In some examples, the inter-station communications manager 745 may provide an X2 interface within an LTE/LTE-A wireless communications network technology to provide communication between network entities 105.

The communications manager 720 may support wireless communication at a centralized control entity in accordance with examples as disclosed herein. For example, the communications manager 720 may be configured as or otherwise support a means for receiving, from a first UE, an indication of a set of target objects tracked by a sensor at the first UE and a level of accuracy for tracking the set of target objects. The communications manager 720 may be configured as or otherwise support a means for receiving, from the first UE, a request for inter-UE tracking assistance to assist the first UE in tracking at least one target object of the set of target objects. The communications manager 720 may be configured as or otherwise support a means for identifying a set of sensor parameters associated with a set of UEs and responsive to the request for inter-UE tracking assistance. The communications manager 720 may be configured as or otherwise support a means for transmitting, to the first UE, assistance information for inter-UE tracking assistance based on the identified set of sensor parameters.

By including or configuring the communications manager 720 in accordance with examples as described herein, the device 705 may support techniques for improved user experience due to enhanced situational awareness, improved coordination between devices, vehicle safety, travel efficiency, and collision avoidance.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for inter-vehicle sensor target tracking as described herein, or the processor 740 and the memory 730 may be otherwise configured to perform or support such operations.

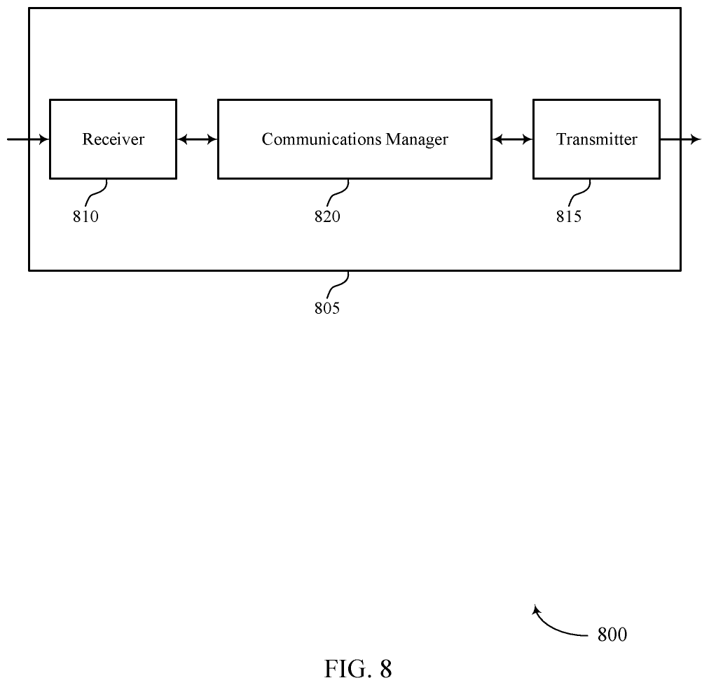

FIG. 8 shows a block diagram 800 of a device 805 that supports techniques for inter-vehicle sensor target tracking in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for inter-vehicle sensor target tracking). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for inter-vehicle sensor target tracking). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for inter-vehicle sensor target tracking as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. For example, the communications manager 820 may be configured as or otherwise support a means for transmitting, to a centralized control entity, an indication of a set of target objects tracked by a sensor at the first UE and a level of accuracy for tracking the set of target objects. The communications manager 820 may be configured as or otherwise support a means for transmitting, to the centralized control entity, a request for inter-UE tracking assistance to assist the first UE in tracking at least one target object of the set of target objects. The communications manager 820 may be configured as or otherwise support a means for receiving, from the centralized control entity, assistance information for inter-UE tracking assistance based on a set of sensor parameters associated with a set of UEs and responsive to the request for inter-UE tracking assistance.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources.

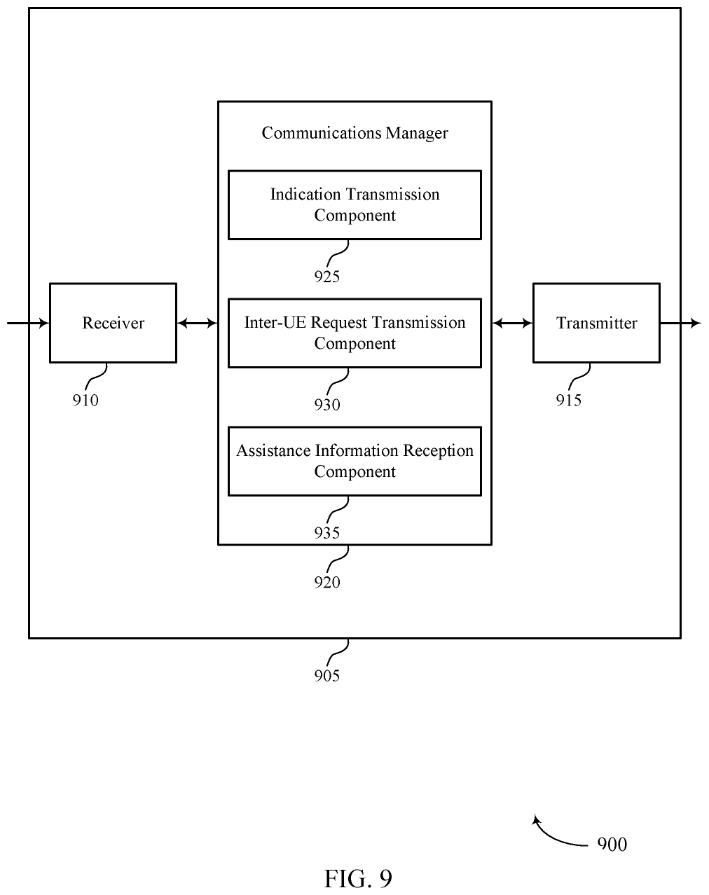

FIG. 9 shows a block diagram 900 of a device 905 that supports techniques for inter-vehicle sensor target tracking in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for inter-vehicle sensor target tracking). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for inter-vehicle sensor target tracking). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for inter-vehicle sensor target tracking as described herein. For example, the communications manager 920 may include an indication transmission component 925, an inter-UE request transmission component 930, an assistance information reception component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first UE in accordance with examples as disclosed herein. The indication transmission component 925 may be configured as or otherwise support a means for transmitting, to a centralized control entity, an indication of a set of target objects tracked by a sensor at the first UE and a level of accuracy for tracking the set of target objects. The inter-UE request transmission component 930 may be configured as or otherwise support a means for transmitting, to the centralized control entity, a request for inter-UE tracking assistance to assist the first UE in tracking at least one target object of the set of target objects. The assistance information reception component 935 may be configured as or otherwise support a means for receiving, from the centralized control entity, assistance information for inter-UE tracking assistance based on a set of sensor parameters associated with a set of UEs and responsive to the request for inter-UE tracking assistance.

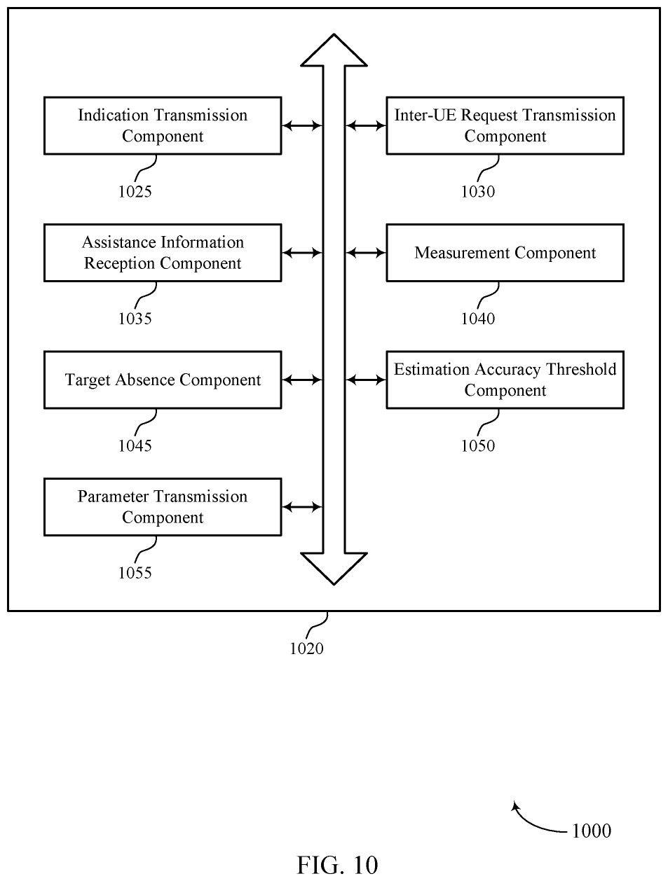

FIG. 10 shows a block diagram 1000 of a communications manager 1020 that supports techniques for inter-vehicle sensor target tracking in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for inter-vehicle sensor target tracking as described herein. For example, the communications manager 1020 may include an indication transmission component 1025, an inter-UE request transmission component 1030, an assistance information reception component 1035, a measurement component 1040, a target absence component 1045, an estimation accuracy threshold component 1050, a parameter transmission component 1055, or any combination thereof. Each of these components may communicate, directly or indirectly, with one another (e.g., via one or more buses).

The communications manager 1020 may support wireless communication at a first UE in accordance with examples as disclosed herein. The indication transmission component 1025 may be configured as or otherwise support a means for transmitting, to a centralized control entity, an indication of a set of target objects tracked by a sensor at the first UE and a level of accuracy for tracking the set of target objects. The inter-UE request transmission component 1030 may be configured as or otherwise support a means for transmitting, to the centralized control entity, a request for inter-UE tracking assistance to assist the first UE in tracking at least one target object of the set of target objects. The assistance information reception component 1035 may be configured as or otherwise support a means for receiving, from the centralized control entity, assistance information for inter-UE tracking assistance based on a set of sensor parameters associated with a set of UEs and responsive to the request for inter-UE tracking assistance.

In some examples, the measurement component 1040 may be configured as or otherwise support a means for performing a set of measurements using the sensor at the first UE. In some examples, the target absence component 1045 may be configured as or otherwise support a means for determining that the at least one target object is absent in the set of measurements, where transmitting the request for inter-UE tracking assistance is based on determining that the at least one target object is absent in the set of measurements.

In some examples, the estimation accuracy threshold component 1050 may be configured as or otherwise support a means for determining that a target estimation accuracy associated with the at least one target object does not satisfy a threshold, where transmitting the request for inter-UE tracking assistance is based on determining that the target estimation accuracy does not satisfy the threshold. In some examples, the parameter transmission component 1055 may be configured as or otherwise support a means for transmitting, to the centralized control entity, one or more parameters prior to transmitting the request for inter-UE tracking assistance.

In some examples, transmitting the one or more parameters includes a periodic transmission of the one or more parameters, or an event-triggered transmission of the one or more parameters, or both. In some examples, the one or more parameters include at least one of a location, a mobility, a predicted behavior, a predicted path, a sensor performance specification, a tracked target object list, a predicted target object list with predicted estimation accuracies, or a combination thereof.

In some examples, the request for inter-UE tracking assistance includes a periodic request for inter-UE tracking assistance, or an event-based request for inter-UE tracking assistance, or both. In some examples, the first UE includes a vehicular UE and the centralized control entity includes a road-side unit. In some examples, the sensor includes a radar sensor, or a lidar sensor, or both.

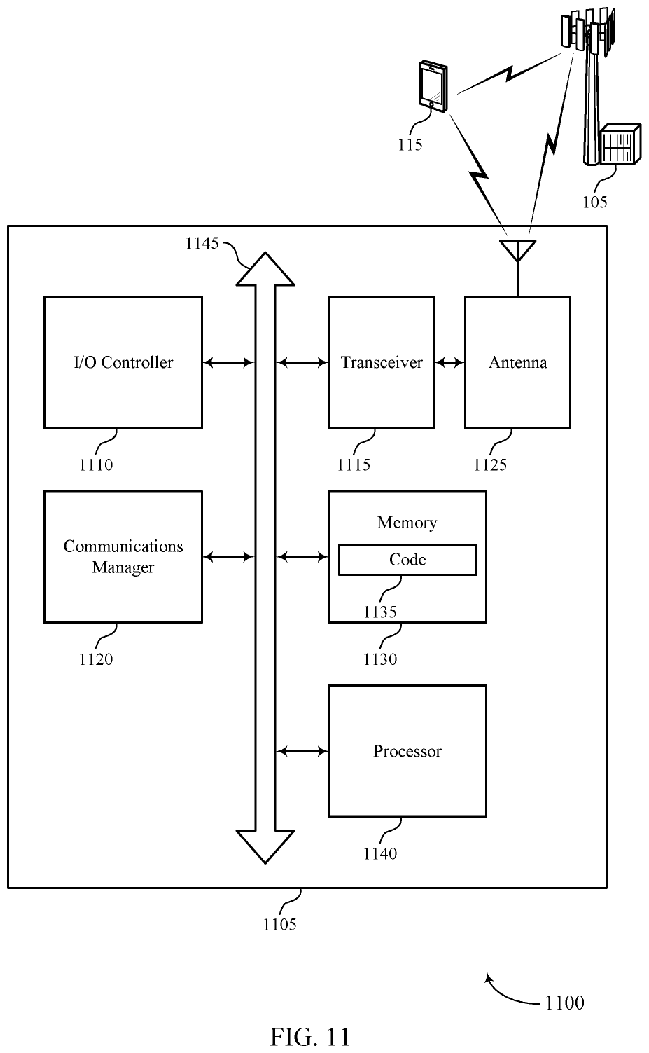

FIG. 11 shows a diagram of a system 1100 including a device 1105 that supports techniques for inter-vehicle sensor target tracking in accordance with aspects of the present disclosure. The device 1105 may be an example of or include the components of a device 805, a device 905, or a UE 115 as described herein. The device 1105 may communicate wirelessly with one or more network entities 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for inter-vehicle sensor target tracking). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a first UE in accordance with examples as disclosed herein. For example, the communications manager 1120 may be configured as or otherwise support a means for transmitting, to a centralized control entity, an indication of a set of target objects tracked by a sensor at the first UE and a level of accuracy for tracking the set of target objects. The communications manager 1120 may be configured as or otherwise support a means for transmitting, to the centralized control entity, a request for inter-UE tracking assistance to assist the first UE in tracking at least one target object of the set of target objects. The communications manager 1120 may be configured as or otherwise support a means for receiving, from the centralized control entity, assistance information for inter-UE tracking assistance based on a set of sensor parameters associated with a set of UEs and responsive to the request for inter-UE tracking assistance.

By including or configuring the communications manager 1120 in accordance with examples as described herein, the device 1105 may support techniques for improved user experience due to enhanced situational awareness, improved coordination between devices, vehicle safety, travel efficiency, and collision avoidance.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for inter-vehicle sensor target tracking as described herein, or the processor 1140 and the memory 1130 may be otherwise configured to perform or support such operations.

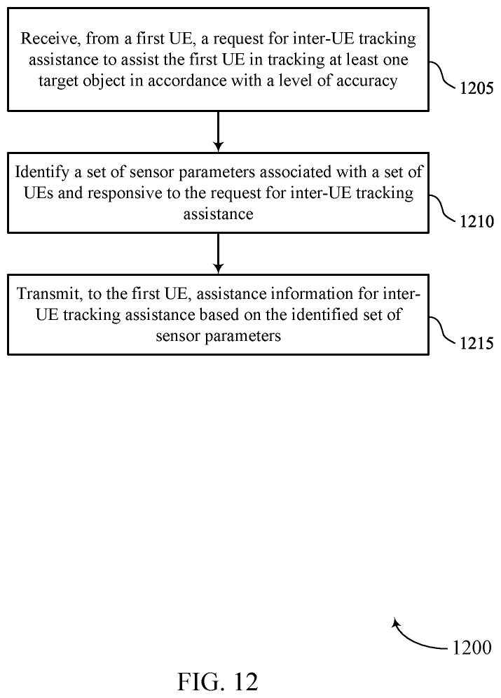

FIG. 12 shows a flowchart illustrating a method 1200 that supports techniques for inter-vehicle sensor target tracking in accordance with aspects of the present disclosure. The operations of the method 1200 may be implemented by a centralized control entity or its components as described herein. For example, the operations of the method 1200 may be performed by a centralized control entity as described with reference to FIGS. 1 through 7. In some examples, a centralized control entity may execute a set of instructions to control the functional elements of the centralized control entity to perform the described functions. Additionally or alternatively, the centralized control entity may perform aspects of the described functions using special-purpose hardware.

At 1205, the method may include receiving, from a first UE, a request for inter-UE tracking assistance to assist the first UE in tracking at least one target object in accordance with a level of accuracy. The operations of 1205 may be performed in accordance with examples as disclosed herein. In some examples, aspects of the operations of 1205 may be performed by an inter-UE request reception component 625 as described with reference to FIG. 6.

At 1210, the method may include identifying a set of sensor parameters associated with a set of UEs and responsive to the request for inter-UE tracking assistance. The operations of 1210 may be performed in accordance with examples as disclosed herein. In some examples, aspects of the operations of 1210 may be performed by an identification component 630 as described with reference to FIG. 6.

At 1215, the method may include transmitting, to the first UE, assistance information for inter-UE tracking assistance based on the identified set of sensor parameters. The operations of 1215 may be performed in accordance with examples as disclosed herein. In some examples, aspects of the operations of 1215 may be performed by an assistance information transmission component 635 as described with reference to FIG. 6.

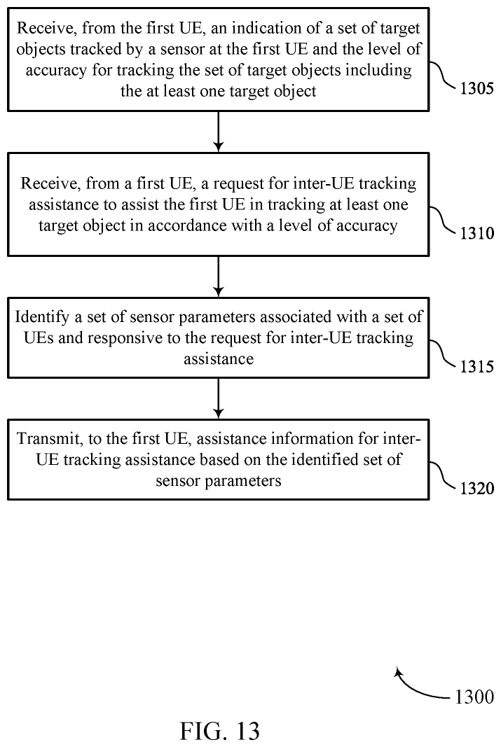

FIG. 13 shows a flowchart illustrating a method 1300 that supports techniques for inter-vehicle sensor target tracking in accordance with aspects of the present disclosure. The operations of the method 1300 may be implemented by a centralized control entity or its components as described herein. For example, the operations of the method 1300 may be performed by a centralized control entity as described with reference to FIGS. 1 through 7. In some examples, a centralized control entity may execute a set of instructions to control the functional elements of the centralized control entity to perform the described functions. Additionally or alternatively, the centralized control entity may perform aspects of the described functions using special-purpose hardware.

At 1305, the method may include receiving, from the first UE, an indication of a set of target objects tracked by a sensor at the first UE and the level of accuracy for tracking the set of target objects including the at least one target object. The operations of 1305 may be performed in accordance with examples as disclosed herein. In some examples, aspects of the operations of 1305 may be performed by an indication reception component 640 as described with reference to FIG. 6.

At 1310, the method may include receiving, from a first UE, a request for inter-UE tracking assistance to assist the first UE in tracking at least one target object in accordance with a level of accuracy. The operations of 1310 may be performed in accordance with examples as disclosed herein. In some examples, aspects of the operations of 1310 may be performed by an inter-UE request reception component 625 as described with reference to FIG. 6.

At 1315, the method may include identifying a set of sensor parameters associated with a set of UEs and responsive to the request for inter-UE tracking assistance. The operations of 1315 may be performed in accordance with examples as disclosed herein. In some examples, aspects of the operations of 1315 may be performed by an identification component 630 as described with reference to FIG. 6.

At 1320, the method may include transmitting, to the first UE, assistance information for inter-UE tracking assistance based on the identified set of sensor parameters. The operations of 1320 may be performed in accordance with examples as disclosed herein. In some examples, aspects of the operations of 1320 may be performed by an assistance information transmission component 635 as described with reference to FIG. 6.

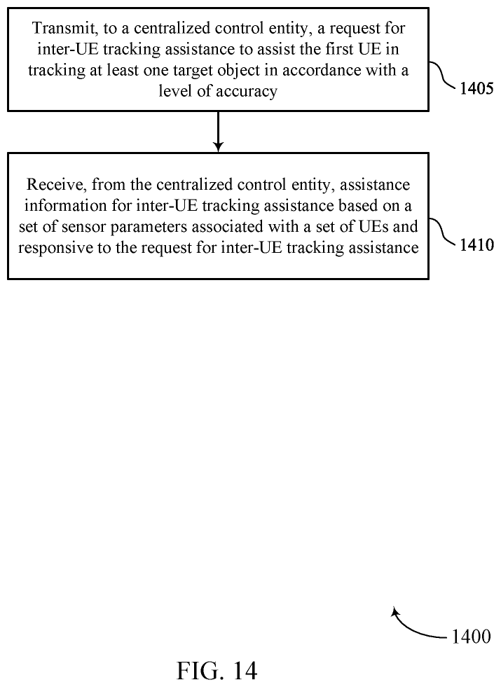

FIG. 14 shows a flowchart illustrating a method 1400 that supports techniques for inter-vehicle sensor target tracking in accordance with aspects of the present disclosure. The operations of the method 1400 may be implemented by a UE or its components as described herein. For example, the operations of the method 1400 may be performed by a UE 115 as described with reference to FIGS. 1 through 3 and 8 through 11. In some examples, a UE may execute a set of instructions to control the functional elements of the UE to perform the described functions. Additionally or alternatively, the UE may perform aspects of the described functions using special-purpose hardware.

At 1405, the method may include transmitting, to a centralized control entity, a request for inter-UE tracking assistance to assist the first UE in tracking at least one target object in accordance with a level of accuracy. The operations of 1405 may be performed in accordance with examples as disclosed herein. In some examples, aspects of the operations of 1405 may be performed by an inter-UE request transmission component 1025 as described with reference to FIG. 10.

At 1410, the method may include receiving, from the centralized control entity, assistance information for inter-UE tracking assistance based on a set of sensor parameters associated with a set of UEs and responsive to the request for inter-UE tracking assistance. The operations of 1410 may be performed in accordance with examples as disclosed herein. In some examples, aspects of the operations of 1410 may be performed by an assistance information reception component 1030 as described with reference to FIG. 10.

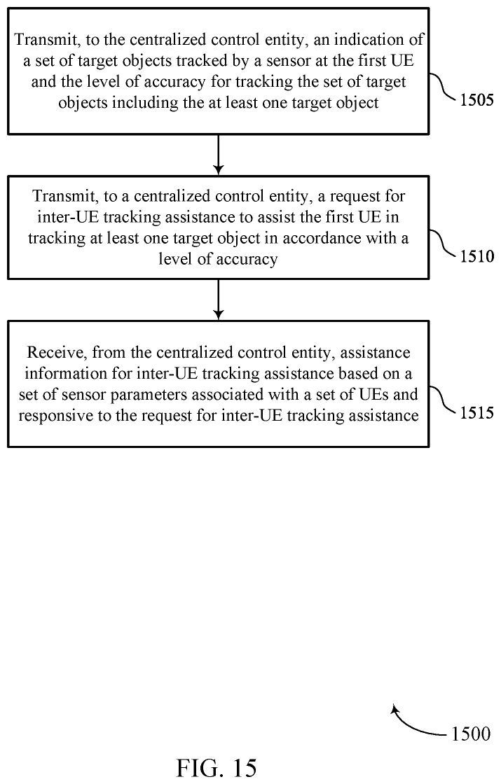

FIG. 15 shows a flowchart illustrating a method 1500 that supports techniques for inter-vehicle sensor target tracking in accordance with aspects of the present disclosure. The operations of the method 1500 may be implemented by a UE or its components as described herein. For example, the operations of the method 1500 may be performed by a UE 115 as described with reference to FIGS. 1 through 3 and 8 through 11. In some examples, a UE may execute a set of instructions to control the functional elements of the UE to perform the described functions. Additionally or alternatively, the UE may perform aspects of the described functions using special-purpose hardware.

At 1505, the method may include transmitting, to the centralized control entity, an indication of a set of target objects tracked by a sensor at the first UE and the level of accuracy for tracking the set of target objects including the at least one target object. The operations of 1505 may be performed in accordance with examples as disclosed herein. In some examples, aspects of the operations of 1505 may be performed by an indication transmission component 1035 as described with reference to FIG. 10.

At 1510, the method may include transmitting, to a centralized control entity, a request for inter-UE tracking assistance to assist the first UE in tracking at least one target object in accordance with a level of accuracy. The operations of 1510 may be performed in accordance with examples as disclosed herein. In some examples, aspects of the operations of 1510 may be performed by an inter-UE request transmission component 1025 as described with reference to FIG. 10.

At 1515, the method may include receiving, from the centralized control entity, assistance information for inter-UE tracking assistance based on a set of sensor parameters associated with a set of UEs and responsive to the request for inter-UE tracking assistance. The operations of 1515 may be performed in accordance with examples as disclosed herein. In some examples, aspects of the operations of 1515 may be performed by an assistance information reception component 1030 as described with reference to FIG. 10.

The following provides an overview of aspects of the present disclosure:

Aspect 1: A method for wireless communication at a centralized control entity, comprising: receiving, from a first UE, a request for inter-UE tracking assistance to assist the first UE in tracking at least one target object in accordance with a level of accuracy; identifying a set of sensor parameters associated with a set of UEs and responsive to the request for inter-UE tracking assistance; and transmitting, to the first UE, assistance information for inter-UE tracking assistance based at least in part on the identified set of sensor parameters.

Aspect 2: The method of aspect 1, further comprising: receiving, from the first UE, an indication of a set of target objects tracked by a sensor at the first UE and the level of accuracy for tracking the set of target objects comprising the at least one target object.

Aspect 3: The method of any of aspects 1 through 2, further comprising: transmitting, to the set of UEs, a request for the set of sensor parameters in response to the request for inter-UE tracking assistance.

Aspect 4: The method of aspect 3, further comprising: receiving, from the set of UEs, a set of responses to the request for the set of sensor parameters, wherein identifying the set of sensor parameters associated with the set of UEs is based at least in part on the set of responses.

Aspect 5: The method of aspect 4, further comprising: determining that a target estimation accuracy associated with the at least one target object for at least one of the set of responses satisfies an accuracy threshold; and including the target estimation accuracy for the at least one response in the set of sensor parameters based at least in part on the determining that the target estimation accuracy satisfies the accuracy threshold.

Aspect 6: The method of any of aspects 1 through 5, further comprising: selecting the set of UEs based at least in part on the indication of the set of target objects, the level of accuracy for tracking the set of target objects, and the request for inter-UE tracking assistance.

Aspect 7: The method of aspect 6, further comprising: receiving a capability indication from each UE of the set of UEs, the capability indication indicating that each UE of the set of UEs is capable of participating in inter-UE tracking assistance, wherein selecting the set of UEs is based at least in part on the received capability indication.

Aspect 8: The method of any of aspects 6 through 7, wherein selecting the set of UEs is further based at least in part on at least one of a location for each UE of the set of UEs, a sector for each UE of the set of UEs, a mobility for each UE of the set of UEs, or a combination thereof.

Aspect 9: The method of any of aspects 1 through 8, further comprising: allocating a set of resources to the set of UEs based at least in part on receiving the request for inter-UE tracking assistance, wherein the set of sensor parameters is based at least in part on the allocated set of resources.

Aspect 10: The method of aspect 9, wherein allocating the set of resources to the set of UEs further comprises: allocating at least one of a set of time resources, a frequency band, a set of waveform parameters, or a combination thereof.

Aspect 11: The method of any of aspects 1 through 10, further comprising: receiving, from the first UE, one or more parameters prior to receiving the request for inter-UE tracking assistance.

Aspect 12: The method of aspect 11, wherein receiving the one or more parameters comprises a periodic reception of the one or more parameters, or an event-triggered reception of the one or more parameters, or both.

Aspect 13: The method of any of aspects 11 through 12, wherein the one or more parameters comprise at least one of a location, a mobility, a predicted behavior, a predicted path, a sensor performance specification, a tracked target object list, a predicted target object list with predicted estimation accuracies, or a combination thereof.

Aspect 14: The method of any of aspects 1 through 13, wherein the request for inter-UE tracking assistance comprises a periodic request for inter-UE tracking assistance, or an event-based request for inter-UE tracking assistance, or both.

Aspect 15: The method of any of aspects 1 through 14, wherein the first UE comprises a vehicular UE and the centralized control entity comprises a road-side unit.

Aspect 16: A method for wireless communication at a first UE, comprising: transmitting, to a centralized control entity, a request for inter-UE tracking assistance to assist the first UE in tracking at least one target object in accordance with a level of accuracy; and receiving, from the centralized control entity, assistance information for inter-UE tracking assistance based at least in part on a set of sensor parameters associated with a set of UEs and responsive to the request for inter-UE tracking assistance.

Aspect 17: The method of aspect 16, further comprising: transmitting, to the centralized control entity, an indication of a set of target objects tracked by a sensor at the first UE and the level of accuracy for tracking the set of target objects comprising the at least one target object.

Aspect 18: The method of any of aspects 16 through 17, further comprising: performing a set of measurements using the sensor at the first UE; and determining that the at least one target object is absent in the set of measurements, wherein transmitting the request for inter-UE tracking assistance is based at least in part on determining that the at least one target object is absent in the set of measurements.

Aspect 19: The method of any of aspects 16 through 18, further comprising: determining that a target estimation accuracy associated with the at least one target object does not satisfy a threshold, wherein transmitting the request for inter-UE tracking assistance is based at least in part on determining that the target estimation accuracy does not satisfy the threshold.

Aspect 20: The method of any of aspects 16 through 19, further comprising: transmitting, to the centralized control entity, one or more parameters prior to transmitting the request for inter-UE tracking assistance.

Aspect 21: The method of aspect 20, wherein transmitting the one or more parameters comprises a periodic transmission of the one or more parameters, or an event-triggered transmission of the one or more parameters, or both.

Aspect 22: The method of any of aspects 20 through 21, wherein the one or more parameters comprise at least one of a location, a mobility, a predicted behavior, a predicted path, a sensor performance specification, a tracked target object list, a predicted target object list with predicted estimation accuracies, or a combination thereof.

Aspect 23: The method of any of aspects 16 through 22, wherein the request for inter-UE tracking assistance comprises a periodic request for inter-UE tracking assistance, or an event-based request for inter-UE tracking assistance, or both.

Aspect 24: The method of any of aspects 16 through 23, wherein the first UE comprises a vehicular UE and the centralized control entity comprises a road-side unit.

Aspect 25: An apparatus for wireless communication at a centralized control entity, comprising a processor; memory coupled with the processor; and instructions stored in the memory and executable by the processor to cause the apparatus to perform a method of any of aspects 1 through 15.

Aspect 26: An apparatus for wireless communication at a centralized control entity, comprising at least one means for performing a method of any of aspects 1 through 15.

Aspect 27: A non-transitory computer-readable medium storing code for wireless communication at a centralized control entity, the code comprising instructions executable by a processor to perform a method of any of aspects 1 through 15.

Aspect 28: An apparatus for wireless communication at a first UE, comprising a processor; memory coupled with the processor; and instructions stored in the memory and executable by the processor to cause the apparatus to perform a method of any of aspects 16 through 24.

Aspect 29: An apparatus for wireless communication at a first UE, comprising at least one means for performing a method of any of aspects 16 through 24.

Aspect 30: A non-transitory computer-readable medium storing code for wireless communication at a first UE, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a centralized control entity, comprising:
receiving, from a first user equipment (UE), a request for inter-UE tracking assistance to assist the first UE in tracking at least one target object in accordance with a level of accuracy;
identifying a set of sensor parameters associated with a set of UEs and responsive to the request for inter-UE tracking assistance; and
transmitting, to the first UE, assistance information for inter-UE tracking assistance based at least in part on the identified set of sensor parameters.

2. The method of claim 1, further comprising:
receiving, from the first UE, an indication of a set of target objects tracked by a sensor at the first UE and the level of accuracy for tracking the set of target objects comprising the at least one target object.

3. The method of claim 1, further comprising:
transmitting, to the set of UEs, a request for the set of sensor parameters in response to the request for inter-UE tracking assistance.

4. The method of claim 3, further comprising:
receiving, from the set of UEs, a set of responses to the request for the set of sensor parameters, wherein identifying the set of sensor parameters associated with the set of UEs is based at least in part on the set of responses.

5. The method of claim 4, further comprising:
determining that a target estimation accuracy associated with the at least one target object for at least one of the set of responses satisfies an accuracy threshold; and
including the target estimation accuracy for at least one response in the set of sensor parameters based at least in part on the determining that the target estimation accuracy satisfies the accuracy threshold.

6. The method of claim 1, further comprising:
selecting the set of UEs based at least in part on an indication of the set of target objects, the level of accuracy for tracking the set of target objects, and the request for inter-UE tracking assistance.

7. The method of claim 6, further comprising:
receiving a capability indication from each UE of the set of UEs, the capability indication indicating that each UE of the set of UEs is capable of participating in inter-UE tracking assistance, wherein selecting the set of UEs is based at least in part on the received capability indication.

8. The method of claim 6, wherein selecting the set of UEs is further based at least in part on at least one of a location for each UE of the set of UEs, a sector for each UE of the set of UEs, a mobility for each UE of the set of UEs, or a combination thereof.

9. The method of claim 1, further comprising:
allocating a set of resources to the set of UEs based at least in part on receiving the request for inter-UE tracking assistance, wherein the set of sensor parameters is based at least in part on the allocated set of resources.

10. The method of claim 9, wherein allocating the set of resources to the set of UEs further comprises:
allocating at least one of a set of time resources, a frequency band, a set of waveform parameters, or a combination thereof.

11. The method of claim 1, further comprising:
receiving, from the first UE, one or more parameters prior to receiving the request for inter-UE tracking assistance.

12. The method of claim 11, wherein receiving the one or more parameters comprises a periodic reception of the one or more parameters, or an event-triggered reception of the one or more parameters, or both.

13. The method of claim 11, wherein the one or more parameters comprise at least one of a location, a mobility, a predicted behavior, a predicted path, a sensor performance specification, a tracked target object list, a predicted target object list with predicted estimation accuracies, or a combination thereof.

14. The method of claim 1, wherein the request for inter-UE tracking assistance comprises a periodic request for inter-UE tracking assistance, or an event-based request for inter-UE tracking assistance, or both.

15. The method of claim 1, wherein the first UE comprises a vehicular UE and the centralized control entity comprises a road-side unit.

16. A method for wireless communication at a first user equipment (UE), comprising:
transmitting, to a centralized control entity, a request for inter-UE tracking assistance to assist the first UE in tracking at least one target object in accordance with a level of accuracy: and
receiving, from the centralized control entity, assistance information for inter-UE tracking assistance based at least in part on a set of sensor parameters associated with a set of UEs and responsive to the request for inter-UE tracking assistance.

17. The method of claim 16, further comprising:
transmitting, to the centralized control entity, an indication of a set of target objects tracked by a sensor at the first UE and the level of accuracy for tracking the set of target objects comprising the at least one target object.

18. The method of claim 16, further comprising:
performing a set of measurements using the sensor at the first UE; and
determining that the at least one target object is absent in the set of measurements, wherein transmitting the request for inter-UE tracking assistance is based at least in part on determining that the at least one target object is absent in the set of measurements.

19. The method of claim 16, further comprising:
determining that a target estimation accuracy associated with the at least one target object does not satisfy a threshold, wherein transmitting the request for inter-UE tracking assistance is based at least in part on determining that the target estimation accuracy does not satisfy the threshold.

20. The method of claim 16, further comprising:
transmitting, to the centralized control entity, one or more parameters prior to transmitting the request for inter-UE tracking assistance.

21. The method of claim 20, wherein transmitting the one or more parameters comprises a periodic transmission of the one or more parameters, or an event-triggered transmission of the one or more parameters, or both.

22. The method of claim 20, wherein the one or more parameters comprise at least one of a location, a mobility, a predicted behavior, a predicted path, a sensor performance specification, a tracked target object list, a predicted target object list with predicted estimation accuracies, or a combination thereof.

23. The method of claim 16, wherein the request for inter-UE tracking assistance comprises a periodic request for inter-UE tracking assistance, or an event-based request for inter-UE tracking assistance, or both.

24. The method of claim 16, wherein the first UE comprises a vehicular UE and the centralized control entity comprises a road-side unit.

25. An apparatus for wireless communication at a centralized control entity, comprising:
a processor;
memory coupled with the processor; and
instructions stored in the memory and executable by the processor to cause the apparatus to:
receive, from a first user equipment (UE), a request for inter-UE tracking assistance to assist the first UE in tracking at least one target object in accordance with a level of accuracy;
identify a set of sensor parameters associated with a set of UEs and responsive to the request for inter-UE tracking assistance; and
transmit, to the first UE, assistance information for inter-UE tracking assistance based at least in part on the identified set of sensor parameters.

26. The apparatus of claim 25, wherein the instructions are further executable by the processor to cause the apparatus to:
receive, from the first UE, an indication of a set of target objects tracked by a sensor at the first UE and the level of accuracy for tracking the set of target objects comprising the at least one target object; and
select the set of UEs based at least in part on the indication of the set of target objects, the level of accuracy for tracking the set of target objects, and the request for inter-UE tracking assistance.

27. The apparatus of claim 25, wherein the instructions are further executable by the processor to cause the apparatus to:
allocate a set of resources to the set of UEs based at least in part on receiving the request for inter-UE tracking assistance, wherein the set of sensor parameters is based at least in part on the allocated set of resources.

28. An apparatus for wireless communication at a first user equipment (UE), comprising:
a processor:
memory coupled with the processor; and
instructions stored in the memory and executable by the processor to cause the apparatus to:
transmit, to a centralized control entity, a request for inter-UE tracking assistance to assist the first UE in tracking at least one target object in accordance with a level of accuracy; and
receive, from the centralized control entity, assistance information for inter-UE tracking assistance based at least in part on a set of sensor parameters associated with a set of UEs and responsive to the request for inter-UE tracking assistance.

29. The apparatus of claim 28, wherein the instructions are further executable by the processor to cause the apparatus to:
transmit, to the centralized control entity, an indication of a set of target objects tracked by a sensor at the first UE and the level of accuracy for tracking the set of target objects comprising the at least one target object;
perform a set of measurements using the sensor at the first UE; and
determine that the at least one target object is absent in the set of measurements, wherein transmitting the request for inter-UE tracking assistance is based at least in part on determining that the at least one target object is absent in the set of measurements.

30. The apparatus of claim 28, wherein the instructions are further executable by the processor to cause the apparatus to:
determine that a target estimation accuracy associated with the at least one target object does not satisfy a threshold, wherein transmitting the request for inter-UE tracking assistance is based at least in part on determining that the target estimation accuracy does not satisfy the threshold.
